(19) United States
(12) Patent Application Publication
(10) Pub. No.: US 2006/0013976 A1
(43) Pub. Date: Jan. 19, 2006

(54) Neck protector

(76) Inventor: Lisa Ellen Leiss, Bethlehem, PA (US)

Correspondence Address: LISA LEISS, 2240 SONDOR PLACE, BETHLEHEM, PA, 18020, US

(21) Appl. No.: 10/894,071

(22) Filed: Jul. 19, 2004

(51) Int. Cl. B29D 22/00

(52) U.S. Cl. 428/36.1

(57) ABSTRACT

The Neck Protector is a cylindrical-shaped tube made of soft, thick fleece fabric. The dimensions are approximately 20″ long with a 5½″ circumference. The Neck Protector is designed for people who are wearing arm slings, typically after a broken arm or shoulder surgery. The weight of the arm puts a tremendous amount of pressure on the strap of the sling, which has a tendency to rub and dig into the user's neck skin. This, in turn, can become painful and irritating to the user. The Neck Protector creates a soft cushion around the strap, thereby, protecting the skin from harm. The neck protector easily slides over the strap portion of the arm sling. The user then adjusts the Neck Protector to a comfortable position around the back of his neck.

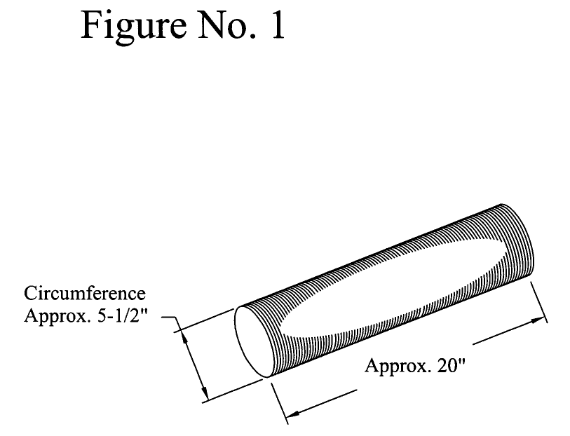

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF INVENTION

The field of endeavor of the Neck Protector is 602.41, a bandage structure that prevents injury to skin.

The Neck Protector fits over any style of arm sling.

After a person receives shoulder surgery, experiences a broken arm or collar bone or has any other kind of injury to their arm or shoulder, quite often the patient wear's his arm in a sling. The weight of the arm puts a tremendous amount of pressure on the strap of the sling, which has a tendency to rub and dig into the neck skin. The skin, in turn, becomes red, irritated and painful.

The Neck Protector creates a cushion around the strap, thereby, protecting the neck skin from harm It easily slides on any style of arm sling. It is easily removed as well.

The Neck Protector is machine washable.

### BRIEF SUMMARY OF THE INVENTION

The Neck Protector is a tube made from soft, thick fleece, which enrobes the strap portion of the neck sling. The Neck Protector creates a cushion around the sling. The strap portion of the sling no longer digs into the patients skin. The soft thick fabric does not irritate the skin.

### BRIEF DESCRIPTION OF THE DRAWING

FIG. I depicts the Neck Protector by its lengthwise view. The shape is essentially a long thin tube. FIG. I also presents the approximate dimensions of the invention. FIG. I does not depict the softness of the fabric. Since the Neck Protector is very simple, I believe only one view is necessary.

### DETAILED DESCRIPTION OF THE INVENTION

I invented the Neck Protector in January 2004 after my husband had shoulder surgery. Initially his neck was in a lot of pain and the skin on his neck was red and irritated because of the arm sling strap rubbing against his neck. I used a piece of fleece fabric and by sewing it into a long tube and sliding it on the arm sling, I created the Neck Protector. Almost immediately, my husband noticed a measurable difference. The Neck Protector created a barrier so the strap would not dig into his neck. The soft, thick fabric prevented the neck skin from becoming irritated.

Shortly thereafter I made Neck Protectors for a neighbor and a friend. Both individuals experienced less or no irritation on their skin.

The Neck Protector is a cylindrical shaped tube made of soft, thick fleece fabric. The dimensions are approximately 20″ long with a 5½″ circumference.

The Neck Protector slides over the strap of an arm sling. The user adjusts the Neck Protector to a comfortable position around the back of his neck. The Neck Protector is long enough to fit around the back of the neck and come down both sides of the arm sling. The diameter of the Neck Protector is wide enough for the sling strap to easily fit through. Therefore, no buttons, zippers, clips, pins or Velcro are needed to use the Neck Protector. The Neck Protector stays in place by the weight of the arm pulling on the sling.

The Neck Protector is manufactured with a rectangular piece of fleece fabric measuring approximately 20″ long by 6″ wide. A single line of straight stitch is sewn down the 20″ length to create the cylindrical shape. A ¼ margin is created on each side. The ends of the cylinder are zig-zagged stitched to prevent the fleece from fraying. This step is added as a precaution since fleece fabric typically does not fray. The cylindrical tube is turned right side out so the seam is hidden in the tube. The Neck Protector is ready to use.

I claim:

1. The Neck Protector is a cylindrical shaped tube, which slides easily over any style of arm sling. The Neck Protector is placed behind the neck where the weight of the sling is burdened. It stays in place by the weight of the arm pulling on the sling.

2. The Neck Protector measures approximately 20″ in length and is made of soft, thick, machine-washable fleece fabric.

3. The Neck Protector minimizes or eliminates the red, irritated, neck skin often experienced by users of arm slings after surgery or injury.
